(19) United States
(12) Patent Application Publication
(10) Pub. No.: US 2011/0049987 A1
(43) Pub. Date: Mar. 3, 2011

(54) Power tap, terminal apparatus and communication system

(75) Inventor: Mitsuru Kobayashi, Shinagawa (JP)

(73) Assignee: FUJITSU COMPONENT LIMITED, Tokyo (JP)

(21) Appl. No.: 12/923,001

(22) Filed: Aug. 27, 2010

(30) Foreign Application Priority Data
Aug. 28, 2009 (JP) 2009-197706

(51) Int. Cl. H02J 3/14

(52) U.S. Cl. 307/31

(57) ABSTRACT

A power tap that supplies an alternating-current power to an terminal apparatus, is connected to the terminal apparatus to configure a closed circuit, and transmits or receives data to/from the terminal apparatus, the power tap including: a plurality of routes including difference loads; a selecting portion that, when data is transmitted to the terminal apparatus, selects any one of the routes based on the transmitted data, in synchronism with timing in which amplitude of an alternating current flowing on the closed circuit becomes 0; and a first detecting portion that, when data is received from the terminal apparatus, detects change of the amplitude of the alternating current based on the received data.

### CROSS-REFERENCE TO RELATED APPLICATION

This application is based upon and claims the benefit of priority of the prior Japanese Patent Application No. 2009-197706, filed on Aug. 28, 2009, the entire contents of which are incorporated herein by reference.

### FIELD

A certain aspect of the embodiments discussed herein is related to a power tap, a terminal apparatus and a communication system.

### BACKGROUND

A device that applies a power tap is developed. The power tap supplies an AC power (i.e., alternating current power) to an outside device. For example, there has been known a remote power controlling apparatus that controls the power tap from a remote place via a network, thereby controlling power supply to a device connected to the power tap. Such a power tap stores parameters for controlling operation of the power tap, and measured data thereinto. The power tap is provided with a communication connector, and communicates with an external terminal apparatus via the communication connector when the parameters are set to the power tap or data is acquired from the power tap. When there is no space for providing the communication connector in the power tap, or when there is not much amount of communication data, the power tap can communicate with the terminal apparatus according to communication using the AC power via an outlet provided on the power tap. As the communication using the AC power, for example, there has been known PLC (Power Line Communication) that can communicate a large mount of data with high speed.

A communication method using a current other than the PLC is proposed. For example, a document 1 (International publication No. WO 2005/109667) discloses a communication method utilizing a power line in which a load current is added to one wavelength of an AC waveform, and an AC (i.e., alternating current) including the processed waveform is transmitted as an information signal. A document 2 (Japanese Laid-Open Patent Application Publication No. 2004-502397) discloses a method of communicating over a power line, the method including a step of modulating a current component of an AC power signal present on the power line.

In the PLC, a circuit is complex and expensive. Further, in the PLC, communication data is superimposed with a power line, and hence a noise occurs to a shortwave radio or a wireless machine by an electric wave emitted from the superimposed signal.

### SUMMARY

According to an aspect of the present invention, there is provided a power tap that supplies an alternating-current power to an terminal apparatus, is connected to the terminal apparatus to configure a closed circuit, and transmits or receives data to/from the terminal apparatus, the power tap including: a plurality of routes including difference loads; a selecting portion that, when data is transmitted to the terminal apparatus, selects any one of the routes based on the transmitted data, in synchronism with timing in which amplitude of an alternating current flowing on the closed circuit becomes 0; and a first detecting portion that, when data is received from the terminal apparatus, detects change of the amplitude of the alternating current based on the received data.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram showing a construction of a communication system according to an exemplary embodiment;

FIG. 2 is a diagram showing a construction of a power tap;

FIG. 3 is a diagram showing a construction of a terminal apparatus;

FIG. 4 is a diagram showing a construction of a circuit of the communication system;

FIG. 5 is a diagram showing a construction of a circuit of the communication system;

FIG. 6 is a diagram showing a relationship between on/off signals of triacs T1 and T2, and an AC I1;

FIG. 7 is a diagram showing a construction of a circuit of the communication system;

FIG. 8 is a diagram showing a relationship between an on/off signal of a triac T3, and an AC I2; and

FIG. 9 is a diagram showing a construction of the circuit of the communication system.

### DESCRIPTION OF EMBODIMENTS

A description will now be given of an exemplary embodiment with reference to the accompanying drawings.

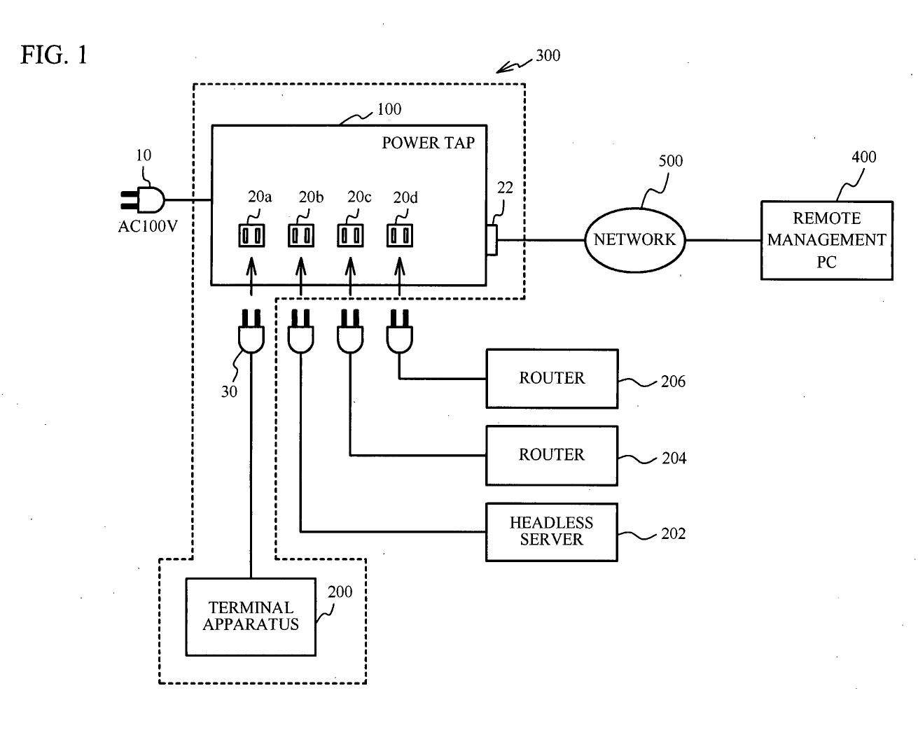

A description will now be given, with reference to FIG. 1, of a construction of a communication system 300 according to an exemplary embodiment. FIG. 1 is a diagram showing a construction of the communication system 300 and surrounding devices. The communication system 300 includes a power tap 100 and a terminal apparatus 200. The power tap 100 includes a power plug 10, outlets 20a, 20b, 20c, and 20d, and a network port 22. The terminal apparatus 200 includes a power plug 30. For example, the power tap 100 receives power supply by connecting the power plug 10 to an outlet from which AC 100V is supplied. The terminal apparatus 200 receives power supply by connecting the power plug 30 to any one of the outlets 20a to 20d on the power tap 100. FIG. 1 illustrates an example of connecting the power plug 30 to the outlet 20a. The power tap 100 and the terminal apparatus 200 transmit or receive data which is a bit sequence by utilizing the connection of the outlet 20a and the power plug 30. The data which the power tap 100 transmits to the terminal apparatus 200 is a current value measured with each of the outlets. The terminal apparatus 200 calculates power consumption by using the received current value, for example. The data which the power tap 100 receives from the terminal apparatus 200 is commands and parameters for the terminal apparatus 200 to designate operation of the power tap 100, for example. One of the commands designates a timer mode, for example. One of the parameter is time for switching on or off each outlet when the timer mode is set, for example. Internal operation of the power tap 100 and the terminal apparatus 200, when data is transmitted or received between the power tap 100 and the terminal apparatus 200, is described later.

As shown in FIG. 1, a headless server 202, and routers 204 and 206 are connected to the outlets 20b, 20c, and 20d of the power tap 100, for example. The headless server 202 can be used without connecting input/output devices. The routers 204 and 206 relay between networks such as LANs (Local Area Networks). The network port 22 of the power tap 100 is connected to a remote management PC 400 via a network 500. The remote management PC 400 is placed at a remote place far away from a server room at which the power tap 100, the terminal apparatus 200, the headless server 202, and the routers 204 and 206 are placed. The remote management PC 400 instructs switching on or off the outlets 20a, 20b, 20c, and 20d to the power tap 100 via the network 500, thereby switching on or off the terminal apparatus 200, the headless server 202, and the routers 204 and 206.

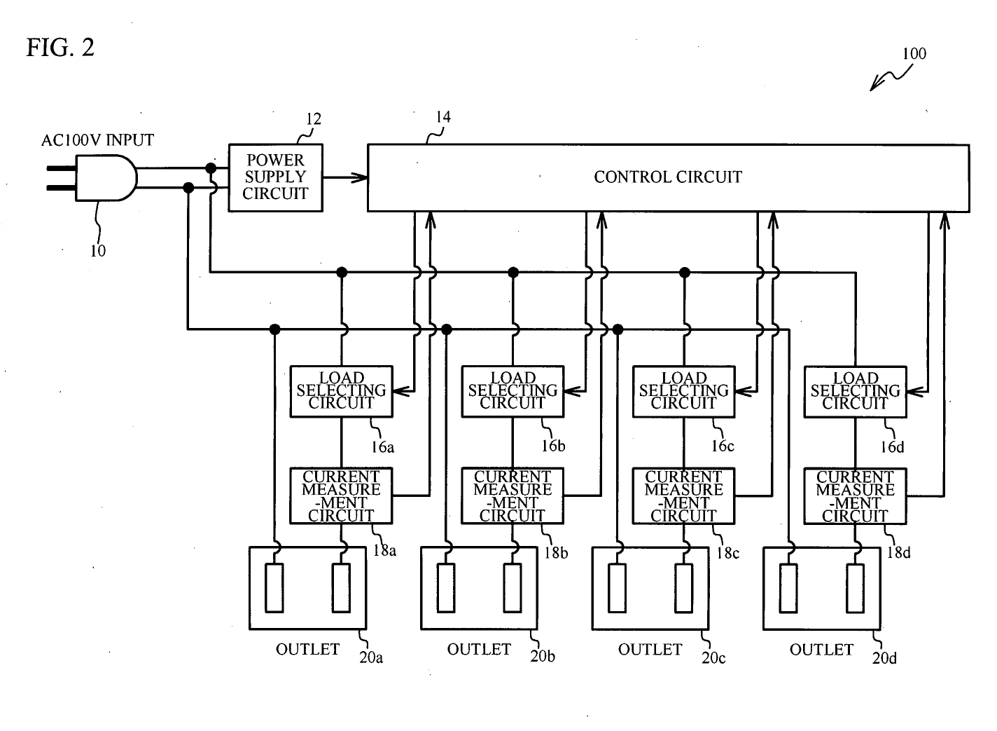

A description will now be given, with reference to FIG. 2, of a construction of the power tap 100 according to the exemplary embodiment. FIG. 2 is a block diagram showing the construction of the power tap 100. The power tap 100 includes the power plug 10, the outlets 20a, 20b, 20c and 20d, a power supply circuit 12, a control circuit 14, load selecting circuits 16a, 16b, 16c and 16d, and current measurement circuits 18a, 18b, 18c and 18d. The power supply circuit 12 converts an AC (Alternating Current) power supply supplied via the power plug 10 into a DC (Direct-Current) power supply. The converted DC power supply is supplied to the control circuit 14. The control circuit 14 selects loads in the load selecting circuits 16a, 16b, 16c, and 16d, and measures amplitude of each of currents measured with the current measurement circuits 18a, 18b, 18c, and 18d.

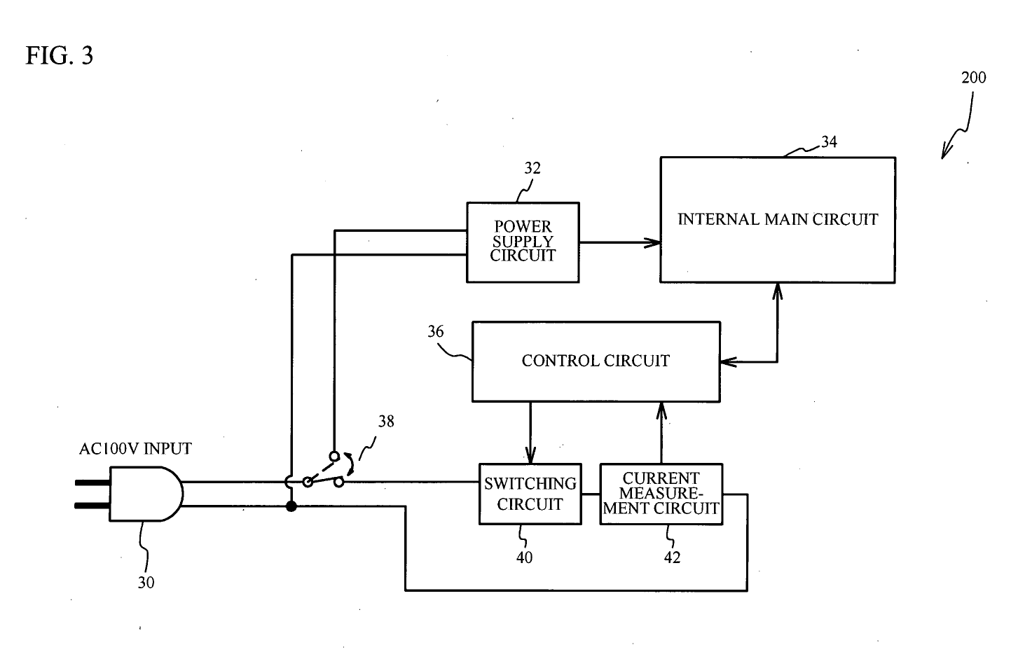

A description will now be given, with reference to FIG. 3, of a construction of the terminal apparatus 200 according to the exemplary embodiment. FIG. 3. is a block diagram showing the construction of the terminal apparatus 200. The terminal apparatus 200 includes a power supply circuit 32, an internal main circuit 34, a control circuit 36, a switch 38, a switching circuit 40 and a current measurement circuit 42. The switch 38 is switched based on whether the terminal apparatus 200 communicates with the power tap 100. When the terminal apparatus 200 communicates with the power tap 100, the switch 38 is switched downward as shown by a solid line in FIG. 3, and hence the power plug 30 is connected to the switching circuit 40 and the current measurement circuit 42. At this time, the control circuit 36 switches on or off a closed circuit via the switching circuit 40, and measures amplitude of a current measured with the current measurement circuit 42. When the terminal apparatus 200 does not communicate with the power tap 100, the switch 38 is switched upward as shown by a broken line in FIG. 3, and hence the power plug 30 is connected to the power supply circuit 32. The power supply circuit 32 converts an AC (Alternating-Current) power supply supplied via the power plug 30 into a DC (Direct-Current) power supply. The converted DC power supply is supplied to the internal main circuit 34. The internal main circuit 34 includes a CPU (Central Processing Unit), a memory, and so on. The internal main circuit 34 generates data of control commands transmitted to the power tap 100, and stores data of a measured value of the current received from the power tap 100.

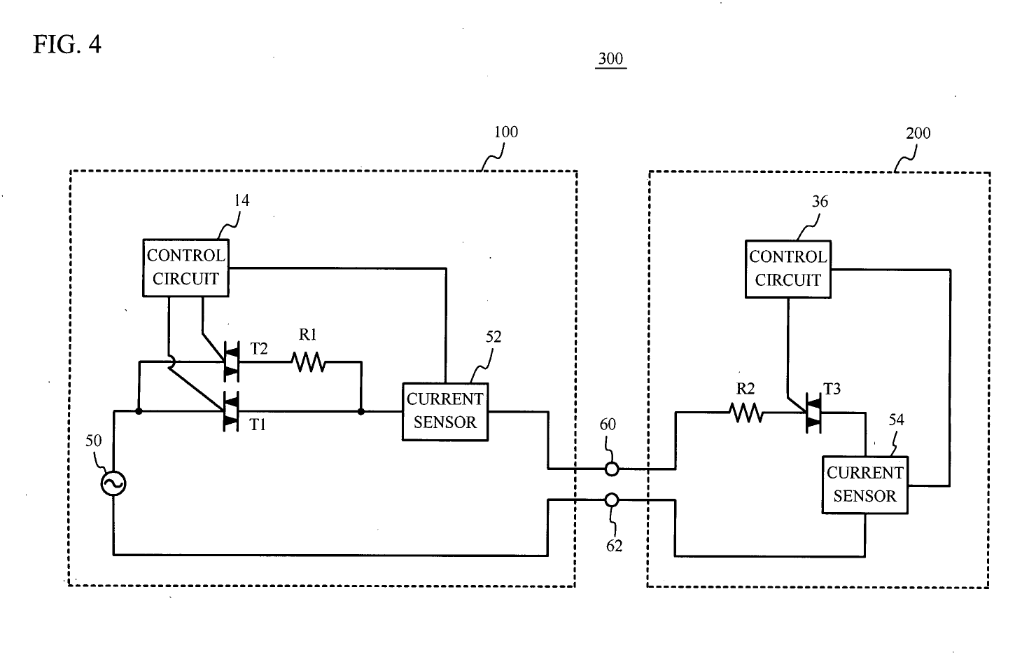

A description will now be given, with reference to FIG. 4, of a construction of the communication system 300 according to the exemplary embodiment. FIG. 4 is a circuit diagram of the communication system 300. In FIG. 4, a left side of terminals 60 and 62 corresponds to the power tap 100, and a right side of the terminals 60 and 62 corresponds to the terminal apparatus 200. Since the power tap 100 and the terminal apparatus 200 are connected by the outlet 20a and the power plug 30 as shown in FIG. 1, the terminals 60 and 62 indicate contact points of the outlet 20a and the power plug 30. The power tap 100 and the terminal apparatus 200 constitute a closed circuit.

The power tap 100 includes an AC power supply 50, the control circuit 14, a current sensor 52, triacs T1 and T2, and a resistance R1. The AC power supply 50 corresponds to an AC power supply connected to the power plug 10 shown in FIG. 2. The current sensor 52 corresponds to the current measurement circuit 18a shown in FIG. 2. The triacs T1 and T2, and the resistance R1 correspond to the load selecting circuit 16a shown in FIG. 2. The triac T1 is connected in series with the closed circuit, and the triac T2 is connected in parallel with the triac T1. The triac T2 is connected in series with the resistance R1. The current sensor 52 is connected in series with the closed circuit, measures amplitude of an alternating current (hereinafter referred to as “AC”) flowing on the closed circuit, and notifies the control circuit 14 of the measured amplitude. The control circuit 14 receives notification of the amplitude of the AC measured with the current sensor 52. The control circuit 14 switches on or off the triacs T1 and T2.

The terminal apparatus 200 includes the control circuit 36, a current sensor 54, a triac T3, and a resistance R2. The triac T3 corresponds to the switching circuit 40 shown in FIG. 3. The current sensor 54 corresponds to the current measurement circuit 42 shown in FIG. 3. The current sensor 54, the triac T3, and the resistance R2 are connected in series with the closed circuit. The current sensor 54 measures amplitude of an AC flowing on the closed circuit, and notifies the control circuit 36 of the measured amplitude. The control circuit 36 receives notification of the amplitude of the AC measured with the current sensor 54. The control circuit 36 switches on or off the triac T3.

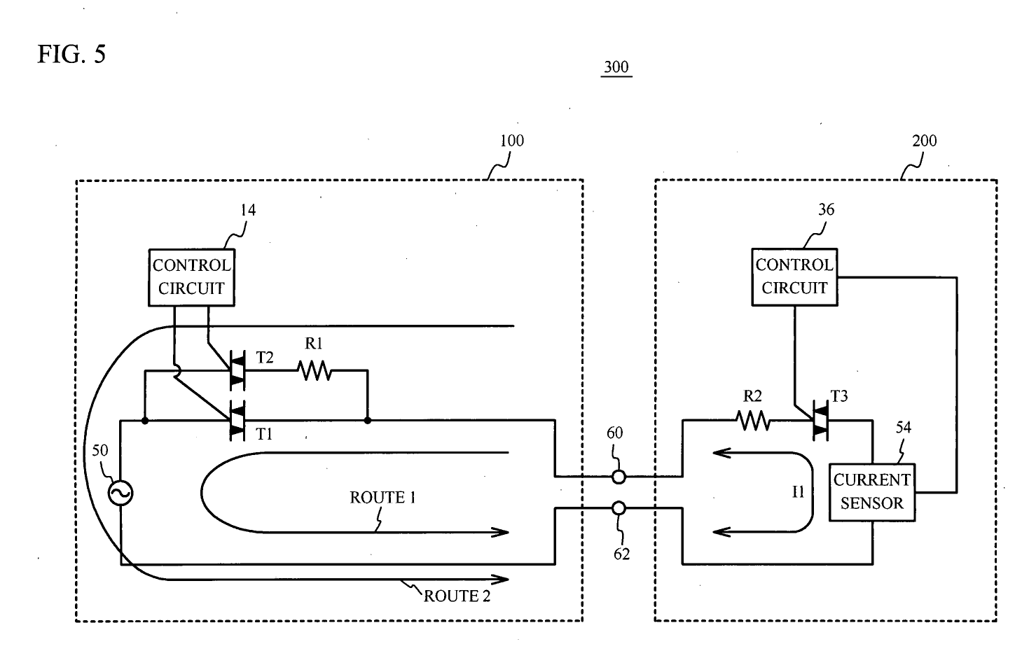

A description will now be given, with reference to FIG. 5, of operation of the communication system 300 when the power tap 100 transmits data to the terminal apparatus 200. FIG. 5 is a circuit diagram showing only a construction relating to a case where the power tap 100 transmits the data to the terminal apparatus 200, in the construction shown in FIG. 4.

The control circuit 14 of the power tap 100, which is a transmission side of data, switches on any one of the triacs T1 and T2 and switches off the remaining one in synchronism with timing in which the amplitude of the AC becomes “0”, i.e., for each half-wave of the AC, based on whether each bit in the bit sequence transmitted to the terminal apparatus 200 is “0” or “1”. When a bit in the bit sequence is “1”, the control circuit 14 switches on the triac T1 and switches off the triac T2. In this case, a route of the AC I1 is a route 1. When a bit in the bit sequence is “0”, the control circuit 14 switches off the triac T1 and switches on the triac T2. In this case, a route of the AC I1 is a route 2. As shown in FIG. 5, the route 2 differs from the route 1 in including the resistance R1. Therefore, the amplitude of the AC I1 flowing on the route 2 is smaller than that of the AC I1 flowing on the route 1.

In the terminal apparatus 200 which is a reception side of data, the triac T3 is always switched on by the control circuit 36. The amplitude of the AC I1 measured with the current sensor 54 changes for each half-wave of the AC I1. The current sensor 54 measures the amplitude of the AC I1, and notifies the control circuit 36 of the measured amplitude, for each half-wave of the AC I1. The control circuit 36 detects a size of the notified amplitude for each half-wave of the AC I1. The control circuit 36 judges whether each bit transmitted from the power tap 100 is “0” or “1”, based on the size of the amplitude of the AC I1. Thereby, the control circuit 36 receives the bit sequence.

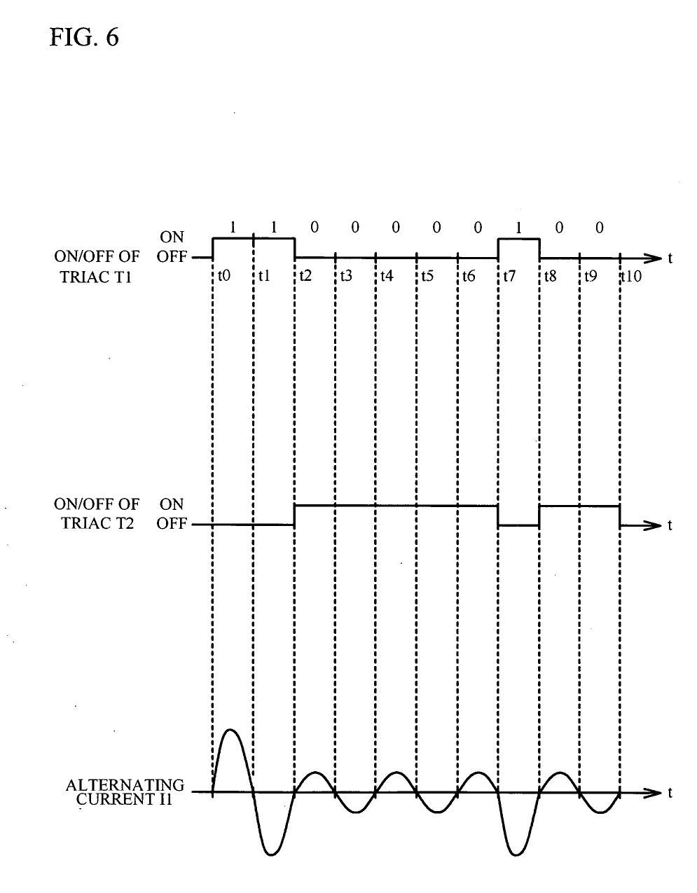

A description will now be given, with reference to FIG. 6, of a relationship between on/off signals of the triacs T1 and T2, and the AC I1 when the power tap 100 transmits data to the terminal apparatus 200. FIG. 6 is a diagram showing the relationship between the on/off signals of the triacs T1 and T2, and the AC I1. FIG. 6 illustrates, in order from the top downwards, the on/off signal of the triac T1, the on/off signal of the triac T2, and the AC I1. Lateral axes in FIG. 6 indicate time t, and each interval from time tn to time t(n+1) (n=0 to 9) corresponds to a half-wave period of the AC I1.

It is assumed that, in FIG. 6, the data which the power tap 100 transmits to the terminal apparatus 200 is a bit sequence “01000001 (41 h of a hexadecimal form)” corresponding to “A” of an ASCII (American Standard Code for Information Interchange) character code. The bit sequence is sequentially transmitted from a least significant bit. In transmission of the bit sequence, “1” which is a start bit is added to a top of the bit sequence, and “0” which is a stop bit is added to an end of the bit sequence.

The control circuit 14 first switches on the triac T1 and switches off the triac T2 from time t0 to time t1, and hence transmits “1” of the start bit to the terminal apparatus 200. Next, the control circuit 14 sequentially transmits the bit sequence “01000001” from the least significant bit, from time t1 to time t9 for each half-wave period. That is, the control circuit 14 switches on the triac T1 and switches off the triac T2 from time t1 to time t2 and from time t7 to time t8, and hence transmits “1” of a first bit and a seventh bit from the least significant bit to the terminal apparatus 200. Further, the control circuit 14 switches off the triac T1 and switches on the triac T2 from time t2 to time t6 and from time t8 to time t9 for each half-wave period, and hence transmits “0” of second to sixth bits and an eighth bit from the least significant bit to the terminal apparatus 200. The control circuit 14 finally switches off the triac T1 and switches on the triac T2 from time t9 to time t10, and hence transmits “0” of the stop bit to the terminal apparatus 200.

The AC I1 flows on the route 1 from time t0 to time t2 and from time t7 to time t8. The AC I1 flows on the route 2 in which the resistance R1 is serially connected, from time t2 to time t6 and from time t8 to time t10. Therefore, as shown in FIG. 6, the amplitude of the AC I1 flowing on the route 2 is smaller than that of the AC I1 flowing on the route 1.

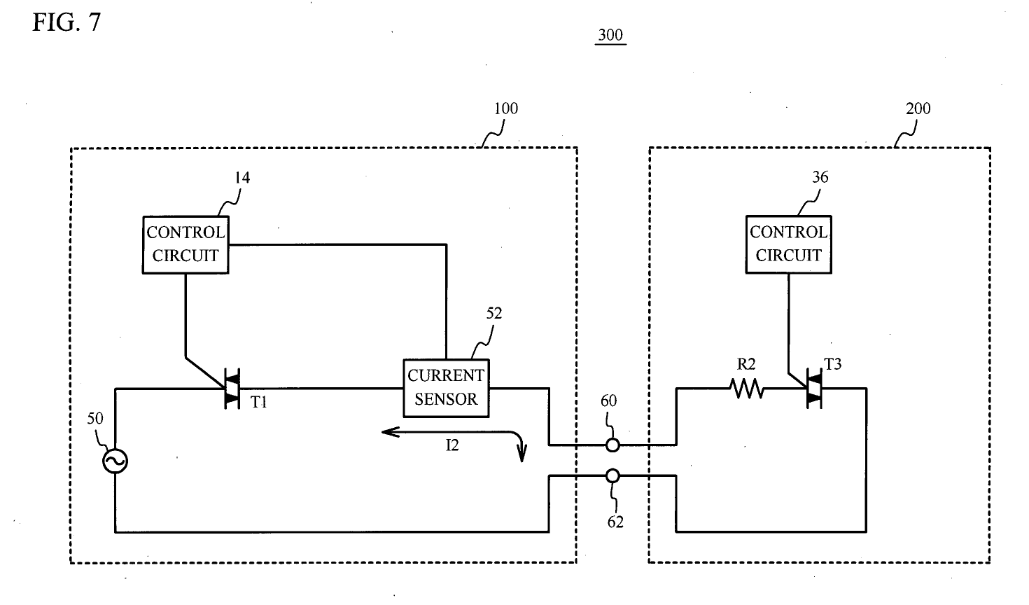

A description will now be given, with reference to FIG. 7, of operation of the communication system 300 when the power tap 100 receives data from the terminal apparatus 200. FIG. 7 shows only a construction relating to a case where the power tap 100 receives the data from the terminal apparatus 200, in the construction shown in FIG. 4.

The control circuit 36 of the terminal apparatus 200, which is a transmission side of data, switches on or off the triac T3 in synchronism with timing in which the amplitude of an AC 12 becomes “0”, i.e., for each half-wave of the AC I2, based on whether each bit in the bit sequence transmitted to the power tap 100 is “0” or “1”. When a bit in the bit sequence is “1”, the control circuit 36 switches on the triac T3. When a bit in the bit sequence is “0”, the control circuit 36 switches off the triac T3. Thereby, the AC I2 flows on the closed circuit when the bit is “1”, and is 0 ampere without flowing on the closed circuit when the bit is “0”.

In the power tap 100 which is a reception side of data, the triac T1 is always switched on by the control circuit 14. The amplitude of the AC I2 measured with the current sensor 52 changes for each half-wave of the AC I2. The current sensor 52 measures the amplitude of the AC I2, and notifies the control circuit 14 of the measured amplitude, for each half-wave of the AC I2. The control circuit 14 detects whether the notified amplitude is “0” for each half-wave of the AC I2. The control circuit 14 judges whether each bit transmitted from the terminal apparatus 200 is “0” or “1”, based on whether the notified amplitude is “0”. Thereby, the control circuit 14 receives the bit sequence.

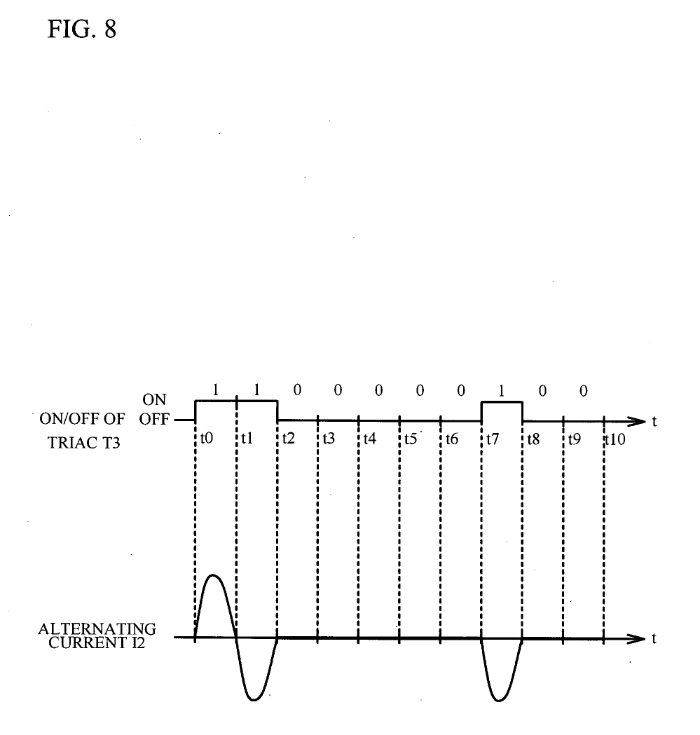

A description will now be given, with reference to FIG. 8, of a relationship between an on/off signal of the triac T3, and the AC I2 when the power tap 100 receives data from the terminal apparatus 200. FIG. 8 is a diagram showing the relationship between the on/off signal of the triac T3, and the AC I2. FIG. 8 illustrates, in order from the top downwards, the on/off signal of the triac T3, and the AC I2. Lateral axes in FIG. 8 are the same as those in FIG. 6.

It is assumed that, similarly to FIG. 6, the data which the power tap 100 receives from the terminal apparatus 200 in FIG. 8 is a bit sequence “01000001” corresponding to “A” of the ASCII character code. The bit sequence is sequentially transmitted from a least significant bit. In transmission of the bit sequence, “1” which is a start bit is added to a top of the bit sequence, and “0” which is a stop bit is added to an end of the bit sequence.

The control circuit 36 first switches on the triac T3 from time t0 to time t1, and hence transmits “1” of the start bit to the power tap 100. Next, the control circuit 36 sequentially transmits the bit sequence “01000001” from the least significant bit, from time t1 to time t9 for each half-wave period. That is, the control circuit 36 switches on the triac T3 from time t1 to time t2 and from time t7 to time t8, and hence transmits “1” of a first bit and a seventh bit from the least significant bit to the power tap 100. Further, the control circuit 36 switches off the triac T3 from time t2 to time t6 and from time t8 to time t9 for each half-wave period, and hence transmits “0” of second to sixth bits and an eighth bit from the least significant bit to the power tap 100. The control circuit 36 finally switches off the triac T3 from time t9 to time t10, and hence transmits “0” of the stop bit to the power tap 100.

The AC I2 flows on the closed circuit from time t0 to time t2 and from time t7 to time t8. The AC I2 does not flow on the closed circuit from time t2 to time t6 and from time t8 to time t10, so that the amplitude of the AC I2 becomes “0”.

According to the exemplary embodiment, as shown in FIGS. 5 and 6, when the power tap 100 transmits data to the terminal apparatus 200, the control circuit 14 and the triacs T1 and T2 select any one of the route 1 never including the resistance R1, and the route 2 including the resistance R1, based on the transmitted data, in synchronism with the timing in which the amplitude of the AC I1 becomes “0”. As shown in FIGS. 7 and 8, when the power tap 100 receives data from the terminal apparatus 200, the control circuit 14 and the current sensor 52 detect change of the amplitude of the AC I2 based on the data. Thereby, a plurality of routes including different loads are switched, so that the data can be transmitted or received without stopping power supply. Further, since the amplitude of the ACs I1 and I2 is made to change with a simple arrangement, the data can be transmitted or received in synchronism with the timing in which the amplitude of the ACs I1 and I2 becomes “0”. Therefore, it is possible to reduce production costs of the power tap 100 and the terminal apparatus 200, and to prevent a noise and a higher harmonic from occurring.

In the exemplary embodiment, the data which the power tap 100 transmits or receives to/from the terminal apparatus 200 is the bit sequence. The control circuit 14 and the triacs T1 and T2 select any one of the route 1 and the route 2 based on the value of each bit in the bit sequence. Thereby, the data can be transmitted or received with a simple arrangement.

In the exemplary embodiment, as shown in FIGS. 7 and 8, when the terminal apparatus 200 transmits data to the power tap 100, the control circuit 36 and the triac T3 switch on or off the closed circuit based on the data, in synchronism with the timing in which the amplitude of the AC I2 flowing on the closed circuit becomes “0”. As shown in FIGS. 5 and 6, when the terminal apparatus 200 receives data from the power tap 100, the current sensor 54 detects change of the amplitude of the AC I1 based on the data. Since the terminal apparatus 200 need not supply a power supply like the power tap 100, the terminal apparatus 200 can achieve transmission of data to the power tap 100 by switching on ore off the closed circuit, without switching the plural routes including different loads. Therefore, the terminal apparatus 200 can be configured more simply. Also, it is possible to switch on ore off the closed circuit in synchronism with the timing in which the amplitude of the AC I2 becomes “0”. Therefore, it is possible to reduce production costs of the power tap 100 and the terminal apparatus 200, and to prevent a noise and a higher harmonic from occurring.

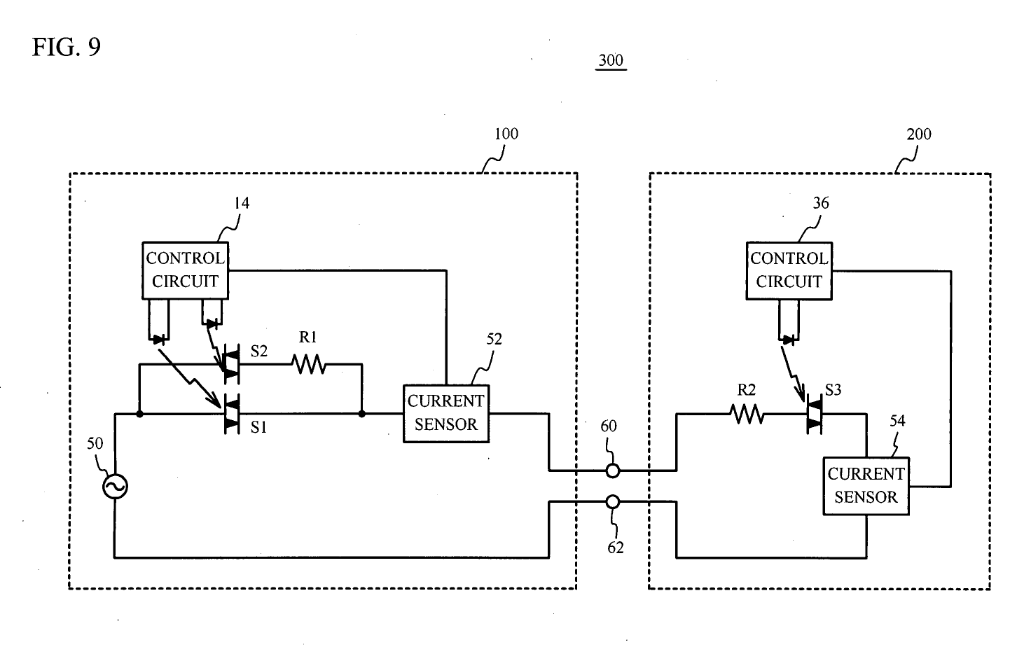

In the exemplary embodiment, the route 1 and the route 2 are switched on or off with the triacs T1 and T2. The closed circuit is switched on or off with the triac T3. Instead of the triacs T1, T2 and T3, solid-state relays S1, S2 and S3 may be used as shown in FIG. 9.

In the exemplary embodiment, instead of the resistances R1 and R2 provided in the closed circuit, constant-current diodes may be used, for example.

In the exemplary embodiment, the ACs I1 and I2 are measured with the current sensors 52 and 54, respectively. Instead of the current sensors 52 and 54, low-resistances may be connected in series with the closed circuit, and voltage indicators may be connected to both ends of the respective low-resistances. The voltage indicators measures voltages of both ends of the respective low-resistances, and then the control circuit 14 and 36 may measure the ACs I1 and I2 from differences of the voltages, respectively.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various change, substitutions, and alterations could be made hereto without departing from the spirit and scope of the invention.

What is claimed is:

1. A power tap that supplies an alternating-current power to an terminal apparatus, is connected to the terminal apparatus to configure a closed circuit, and transmits or receives data to/from the terminal apparatus, the power tap comprising:
a plurality of routes including difference loads;
a selecting portion that, when data is transmitted to the terminal apparatus, selects any one of the routes based on the transmitted data, in synchronism with timing in which amplitude of an alternating current flowing on the closed circuit becomes 0; and
a first detecting portion that, when data is received from the terminal apparatus, detects change of the amplitude of the alternating current based on the received data.

2. The power tap according to claim 1, wherein the data transmitted to or received from the terminal apparatus is a bit sequence, and the selecting portion selects any one of the routes based on a value of each bit in the bit sequence.

3. The power tap according to claim 1, wherein the selecting portion includes triacs switching on or off the routes.

4. The power tap according to claim 1, wherein the selecting portion includes solid-state relays switching on or off the routes.

5. A terminal apparatus that receives an alternating-current power from a power tap, and is connected to the power tap to configure a closed circuit, and transmits or receives data to/from the power tap, the terminal apparatus comprising:
a switching portion that, when data is transmitted to the power tap, switches on or off the closed circuit based on the transmitted data, in synchronism with timing in which amplitude of an alternating current flowing on the closed circuit becomes 0; and
a second detecting portion that, when data is received from the power tap, detects change of the amplitude of the alternating current based on the received data.

6. A communication system having a power tap and a terminal apparatus, comprising:
the power tap that supplies an alternating-current power to the terminal apparatus, is connected to the terminal apparatus to configure a closed circuit, and transmits or receives data to/from the terminal apparatus, the power tap including:
a plurality of routes including difference loads;
a selecting portion that, when data is transmitted to the terminal apparatus, selects any one of the routes based on the transmitted data, in synchronism with timing in which amplitude of an alternating current flowing on the closed circuit becomes 0; and
a first detecting portion that, when data is received from the terminal apparatus, detects change of the amplitude of the alternating current based on the received data; and
the terminal apparatus that receives the alternating-current power from the power tap, the terminal apparatus including:
a switching portion that, when data is transmitted to the power tap, switches on or off the closed circuit based on the transmitted data, in synchronism with timing in which amplitude of an alternating current flowing on the closed circuit becomes 0; and
a second detecting portion that, when data is received from the power tap, detects change of the amplitude of the alternating current based on the received data.
